(19) United States
(12) Patent Application Publication
(10) Pub. No.: US 2013/0214522 A1
(43) Pub. Date: Aug. 22, 2013

(54) PAGE JOG AND LOCK

(71) Applicants: Ellisa A. Stone, Centerville, OH (US); Bobby G. James, Jr., Miamisburg, OH (US); Elizabeth M. Lacher, Columbus, OH (US)

(72) Inventors: Ellisa A. Stone, Centerville, OH (US); Bobby G. James, Jr., Miamisburg, OH (US); Elizabeth M. Lacher, Columbus, OH (US)

(73) Assignee: Acco Brands Corporation, Lincolnshire, IL (US)

(21) Appl. No.: 13/817,639

(22) PCT Filed: Aug. 26, 2011
(86) PCT No.: PCT/US11/49260

§ 371 Date: Apr. 24, 2013

Related U.S. Application Data
(60) Provisional application No. 61/378,617, filed on Aug. 31, 2010.

(51) Int. Cl. B42D 13/00

(52) U.S. Cl. CPC B42D 13/00
USPC 281/15.1

(57) ABSTRACT

An adjustable page is provided. The page has a flexible substrate having a first surface, a second surface, and an edge. The substrate also has a plurality of pairs of first and second apertures, and slits joining the first and second aperture of each pair. The apertures are sized to receive ring connectors which have a leading edge and a trailing edge. The leading edge of each ring connector is designed to separate the slit to allow the ring connector to be transitioned to the appropriate second aperture. The slits are non-linear in shape or are connected to the apertures at positions apart from the centerline between the apertures.

### REFERENCE TO RELATED APPLICATION

This application claims the benefit of priority under 35 U.S.C. §119(e) of U.S. provisional application Ser. No. 61/378,617 filed on Aug. 31, 2010, which is hereby incorporated by reference in its entirety.

### TECHNICAL FIELD

The present invention relates generally to a system for adjusting pages from a first position to a second position, and more specifically to a combination of a binder and page system wherein the pages can be adjusted or “jogged’ up and down.

### BACKGROUND OF THE INVENTION

Binders and insert pages are well known in the art. Standard binders typically provide for retaining the insert pages in a single vertical position. While such binders and insert pages according to the prior art provide a number of advantageous features, they nevertheless have certain limitations. The present invention seeks to overcome certain of these limitations and other drawbacks of the prior art, and to provide new features not heretofore available. A full discussion of the features and advantages of the present invention is deferred to the following detailed description, which proceeds with reference to the accompanying drawings.

### SUMMARY OF THE INVENTION

The present invention generally relates to an adjustable page binder system. The page binder system generally comprises a binder having a plurality of ring connectors and a plurality of pages therein having a plurality of pairs of joined first and second apertures. U.S. Patent Application Publication 2008/0152421 discloses a similar page binder system, which uses a linear slit between the centerlines of the first and second apertures. The present application discloses an improved, non-linear, slit.

According to one embodiment, the pages have a plurality of pairs of first and second apertures, and a non-linear slit joining the first and second apertures of each pair, respectively.

According to another embodiment, the first and second aperture are joined by a slit having a path other than along the centerline between the apertures.

According to another embodiment, the adjustable page binder system may further comprise a first pair of shoulders at the connection between the first apertures and the non-linear slit, and a second pair of shoulders at the connection between the second apertures and the slit. The shoulders are provided to prevent opening of the non-linear slit until an appropriate amount of force is applied to the shoulder by one of the edges of the ring connector. After the ring connector is removed from the slit the shoulder and slit will transition again to the normally closed state.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of an adjustable page binder system with the pages in the first position;

FIG. 2 is a perspective view of the adjustable page binder system of FIG. 1 with one of the pages in the second position;

FIG. 3A is a view of a ring connector for the adjustable page binder system;

FIG. 3B is a cross-sectional view of the ring connector of FIG. 3A;

FIGS. 4A-E are partial cross-sectional views of a ring connector transitioning from a first aperture (i.e., first position) to a second aperture (i.e., second position) using an improved slit design; and

FIGS. 5A-E are top views of several alternative slit designs.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

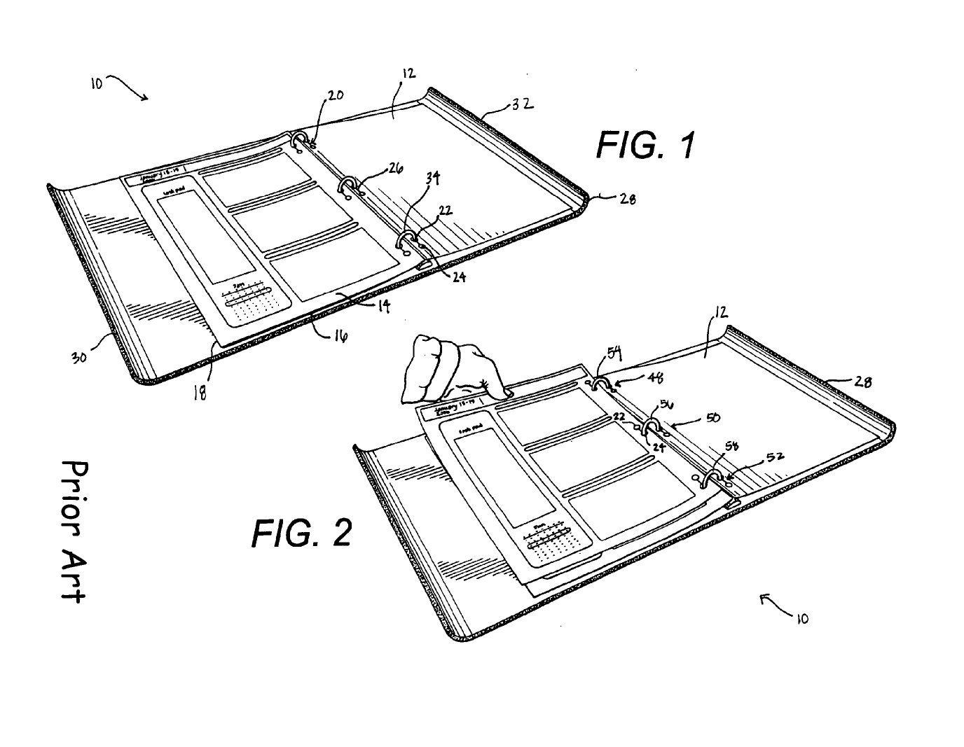

Referring now to the figures, and specifically to FIGS. 1 and 2, there is shown an adjustable page binder system 10. The page binder system 10 comprises a plurality of flexible substrates 12 and a binder 28. Each substrate 12 has a first surface 14, a second surface 16, and an edge 18. Each substrate 12 also has a plurality of pairs 20 of first and second apertures 22, 24. In one embodiment, the pairs of apertures 20 are aligned vertically along the length of the substrate 12. Preferably, the pairs of apertures 20 may be equally spaced apart from one another along the length of the substrate 12.

In one embodiment, a non-linear slit 26 joins the first and second apertures 22, 24 of each pair of apertures 20. The slit may be described as a “page jog” slit. For example, the slit 26 may be a narrow channel which a ring connector 34 can pass through. The slit 26 may have substantially a zero-width, however, other widths may also be used.

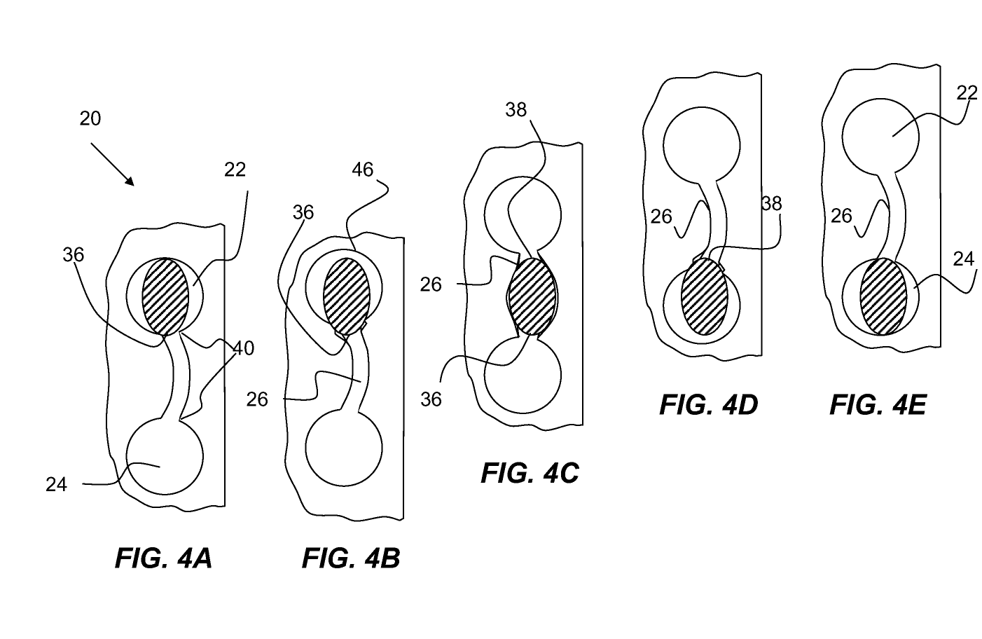

Referring to FIGS. 4A-4E, in one embodiment a first pair of shoulders 40 is located between the first apertures 22 and the non-linear slit 26. A second pair of shoulders 40 is located at the connection between the second apertures 24 and the slit 26. The shoulders 40 may prevent the opening of the slit 26 until an appropriate amount of force is applied to the shoulder 40 by the edges 36, 38 of the ring connector 34. The force that opens the slit 26 results from the interaction between the ring connector 34 and the slit 26, at the shoulder 40 thereof, such that the substrate 12 can be jogged.

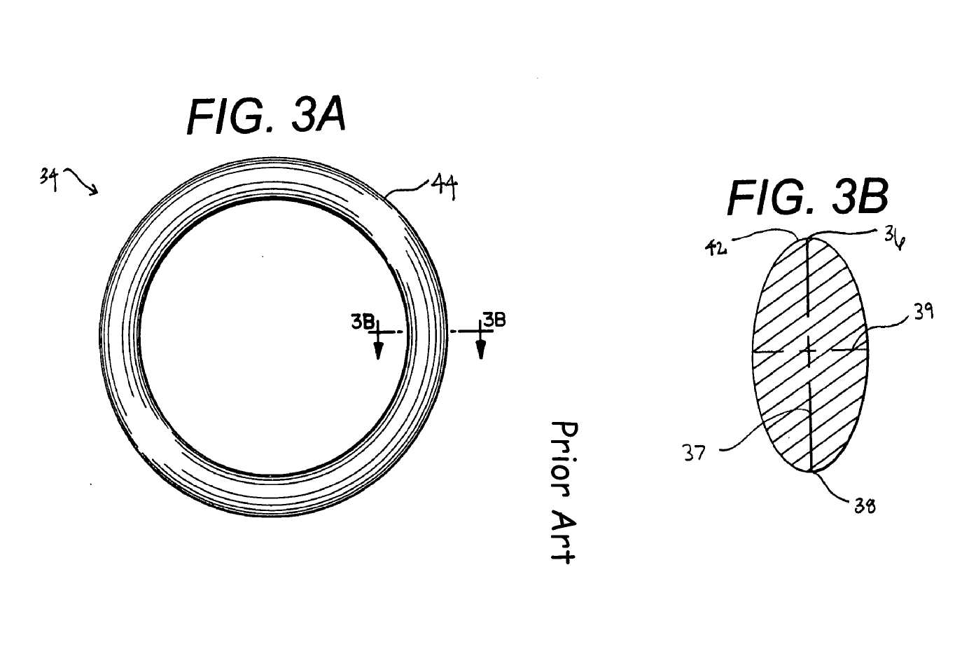

The adjustable page binder system 10 may also comprise a binder 28 having a front cover 30, a back cover 32 and a plurality of ring connectors 34. In one embodiment, the ring connectors 34 are located between the front and back covers 30, 32 of the binder 28, and they are aligned with each other along the length of the binder 28. As shown in FIGS. 3A and 3B, in one embodiment, each ring connector 34 may have a generally elliptical cross-sectional geometry. Further, the generally elliptical cross-sectional geometry of the ring connector 34 may have a major axis 37 that extends generally parallel to a binding 35 of the binder 28, along the length of the binder 28. However, the ring connectors 34 may have cross-sections other than elliptical, for example circular, polygonal, and other shapes.

As shown in the figures, the ring connectors 34 also have a leading edge 36 and a trailing edge 38. The ring connectors 34 are sized to fit within the first and second apertures 22, 24 in the flexible substrate 12 and to allow the pages to be hinged on the ring connectors 34. The ring connectors 34, however, may have a minor diameter 39 that is larger than the non-linear slit 26 thickness (which in one embodiment is approximately zero). The leading edge 36 and trailing edge 38 of each ring connector 34 is designed to open the shoulders 40 and separate the non-linear slit 26, as identified herein.

The geometry of the ring connectors 34 allows the ring connector 34 to separate the non-linear slit 26 and to assist in transitioning the ring connectors 34 from the first aperture 22 to the second aperture 24 within each pair of apertures 20. Once this occurs, the page 12 is “jogged” out of place such that a user can easily find the particular page 12. Thus, to mark a page 12, the user must simply jog the page 12, such that it is retained by the ring connectors 34 in the second apertures 24 respectively, as opposed to identifying the page 12 with a tab, or a post-it note, or folding the page 12. Accordingly, a user can easily set apart and later identify a particular page 12, even if the user does not have anything to mark the page 12 with. Once the user no longer wishes to have a particular page 12 marked, the user need simply jog the page 12 back to its original aligned position in the first set of apertures 22. To jog the page 12 back to its original or first position, the trailing edge 38 of the ring connectors 34 is pushed against the shoulder 40 to open the slit 26 to allow the ring connectors 34 to pass through the slit 26 again in transitioning the ring connectors 34 from the second aperture 24 to the first aperture 22. After the ring connector 34 passes through the slit 26, the shoulder 40 will revert to its original position and the slit 26 will close to prevent any undesired opening of the slit 26. Not only is this method of marking a page 12 simple for the user, it ensures that the substrate 12 will not be damaged from having a tab stuck on and peeled off, or from having been folded.

Thus, the shoulder 40 acts to secure the ring connector 34 in a particular aperture 22, 24 until an appropriate amount of force is applied to move the shoulder 40 and open the non-linear slit 26. For example, as shown in FIG. 4A, when an insufficient amount of force is applied, whether intentionally or inadvertently, the shoulder 40 will abut the leading edge 36 of the ring connector 34, and the shoulder 40 will prevent the ring connector 34 from opening the slit 26. However, once enough force is applied to overcome the shoulder 40, as shown in FIG. 4B, the leading edge 36 will open the slit 26.

Referring to FIGS. 4B-4D, after the leading edge 36 has applied enough pressure to move the shoulder 40 and open the non-linear slit 26, the ring connector 34 may smoothly transition the slit 26 from the normally closed state to the open state as the ring connector 34 passes through the slit 26 from the first aperture 22 to the second 24. After the slit 26 has opened, and the ring connector 34 has transitioned from a first aperture 22 to a second aperture 24, the shoulder 40 at the first aperture 22 closes (see FIG. 4B) and then after the ring connector 34 is fully within the second aperture 24, the shoulder 40 of the second aperture 24 will also close, allowing the slit 26 to close behind the trailing edge 38 of the ring connector 34. The elliptical shape of the cross-section and the smoothness of the ring connector 34 ensures that the slit 26 will smoothly open instead of tearing, and further that the slit 26 will close again after the transition has occurred.

As shown in FIG. 3, the ring connectors 34 have a generally circumferential perimeter 44. However, the perimeter 44 may be in other suitable geometries, such as “D” shaped. In a preferred embodiment, the cross-section of the ring connectors 34 is consistent about the perimeter, such that each point on the ring connector 34 has a leading edge 36 and a trailing edge 38. Thus, the flexible substrates 12 can be “jogged” from the first aperture 22 to the second aperture 24 from any location around the ring connector 34. Moreover, the substrate 12 does not need to be lifted or moved to a certain location along the ring connector 34 before the substrate 12 is jogged. This makes it much easier for the user to jog a substrate 12. Thus, the uniform cross-section of the ring connector 34 about the perimeter 44 creates a move convenient method of jogging.

As shown in FIGS. 4A-4E, in one embodiment the apertures 22, 24 have a diameter 46 corresponding in size to the length of the major axis of the cross-section of the ring connectors 34. This allows the ring connectors 34 to easily be received by both the first and second apertures 22, 24.

The dimensions of the apertures 22, 24 and slit 26 may be chosen according to manufacturing preference, and to fit with particular binders and ring connectors. For example, the apertures 22, 24 may be circular shape and having a diameter of approximately 0.28 inches. The spacing between centers may be approximately 0.59 inches. The slit 26 may have a width of approximately 0.06 inches. In the case of the arc-shaped slit of FIGS. 4A-4E, the opposing edges of the slit may comprise arcs having a radius of approximately 0.28 inches and approximately 0.34 inches. All these dimensions however are only examples.

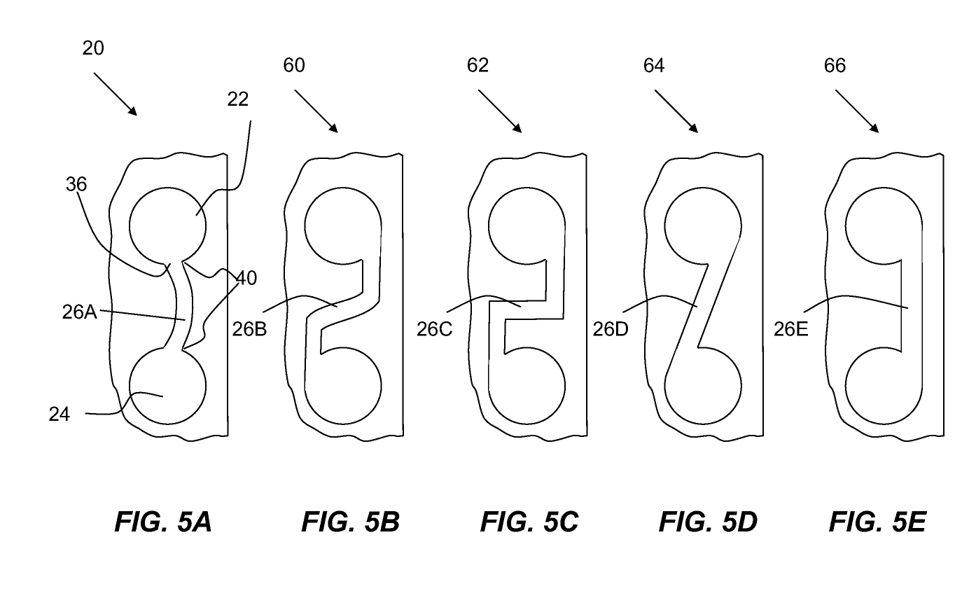

Additional configurations of a non-linear slit are shown in FIGS. 5B-5C, and modified linear slits are shown in FIGS. 5D-5E.

Aperture pair 20 may be connected by an arc-shaped non-linear slit 26A as shown in FIG. 5A (and also in FIGS. 4A-4E), where arc shaped slit is connected to apertures 22, 24 approximately along the centerline between the apertures. However, the arc-shaped slit may also be connected to the apertures at locations around their peripheries other than at the centerline.

Aperture pair 60 may be connected by a non-linear slit 26B comprising an intermediate slanted portion as shown in FIG. 5B, where the slit is connected to apertures 22, 24 approximately tangentially to respective apertures at opposing sides. However, the slanted slit may also be connected to the apertures at other locations than the tangents, where it may enter the aperture at other angles than the tangent. Also, the sloped portion of the slanted non-linear slit may be provided at an angle different from that shown in FIG. 5B.

Aperture pair 62 may be connected by a non-linear slit 26C comprising an intermediate transverse portion approximately perpendicular to the centerline between the apertures, as shown in FIG. 5C, where the slit is connected to apertures 22, 24 approximately tangentially to respective apertures at opposing sides. However, this slit may also be connected to the apertures at other locations than the tangents, where it may enter the aperture at other angles than the tangent. Also, the transverse portion of the slit may be provided at an angle different from that shown in FIG. 5C, that is, at an angle not perpendicular to the centerline between the apertures.

Aperture pair 64 may be connected by a linear slit 26D comprising a slanted intermediate portion as shown in FIG. 5D, where the slit is connected to apertures 22, 24 approximately tangentially to respective apertures at opposing sides. However, this slit may also be connected to the apertures at other locations than the tangents, where it may enter the aperture at other angles than the tangent. Also, the slanted portion of the slit may be provided at an angle different from that shown in FIG. 5D.

Aperture pair 66 may be connected by a linear slit 26E comprising a non-slanted intermediate portion as shown in FIG. 5E, where the slit is connected to apertures 22, 24 approximately tangentially to the same sides of the respective apertures. However, this slit may also be connected to the apertures at other locations than the tangents, where it may enter the aperture at other angles than the tangent.

The slits shown in FIGS. 5A-5E may be combined in various combinations; for example the slit may connect to aperture 22 with an arc-shaped path as shown in FIG. 5A while connecting to aperture 24 with a tangential path as shown in FIG. 5D. The widths of the slit may be chosen according to manufacturing preference, and may be either uniform or non-uniform along the path of the slit. Also, the particular shape of shoulders 40 may be chosen according to manufacturing preference, for example being relatively sharp or having a small radius, or on the other hand being somewhat smoother or having a larger radius.

As shown in FIGS. 1 and 2, the adjustable page binder system 10 may include substrates 12 that have a first, second, and third series 48, 50, 52 of first and second apertures 22, 24, such that there are three pairs 48, 50, 52 of apertures. The system 10 may include a first, second, and third ring connector 54, 56, 58, which are received, respectively, in the first, second, and third series 48, 50, 52 of apertures. The first second and third ring connectors 54, 56, 58 may pass through the corresponding sets of apertures 48, 50, 52, respectively.

Initially, the first, second, and third ring connectors 54, 56, 58 may all be aligned so that they pass through the first aperture 22 in the first second and third series 48, 50, 52, of each of the substrates 12. Thus, all of the substrates 12 are initially aligned. As shown in the series of figures, FIGS. 4A-E, once a certain amount of force is applied, between the ring connector 34 and the appropriate shoulders 40, a substrate 12 will transition such that the first, second, and third ring connectors 54, 56, 58 will be pass from the first aperture 22, through the slits 26 of the substrates 12, and into the second apertures 24. After the ring connectors 54, 56, 58 have transitioned to the second aperture 24 of the first, second, and third series 48, 50, 52 of apertures, the particular substrate 12 will be jogged, making it easily identifiable.

With repeated use of the page jog feature, substrates 12 such as plain paper may become worn so that the paper is more likely to tear out of binding, or the slit may become widened, diminishing its ability to ‘catch’ when jogged. In order to improve the wear properties of substrate 12, the area of the apertures and slits may be laminated, coated, made of more than one ply, or otherwise reinforced. Instead of paper, alternative materials may be used such as tear-resistant paper or plastic materials.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and the claims, is utilized in an open-ended manner.

While the description describes a binder and ring connectors for holding sheets provided with the page jog slits, it should be understood that the sheets may also be provided separately from the binder and ring connectors. Also, besides being used with paper sheets, the page jog slit or slits may also be provided on other products such as dividers, pocket dividers, pockets, folders, sleeves, page markers, and various binder accessories. These products may be tabbed or untabbed and may be made of paper, paperboard, plastic, polypropylene, polyethylene, and other materials.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying Claims.

1. An adjustable page to be received into a plurality of ring connectors each having a leading edge and a trailing edge, the adjustable page comprising:
a substrate having a first surface, a second surface and an edge, the substrate having plurality of pairs of first and second apertures, and a slit joining the first and second apertures of each pair, respectively; and,
wherein the leading edge of the ring connectors are designed to separate the slits to allow the ring connectors to be transitioned to the appropriate second aperture,
wherein a centerline is defined between the centers of the first and second apertures, and
wherein the slit comprises at least one portion that is non-linear or is located along a path apart from said centerline.

2. The adjustable page of claim 1, further comprising a first pair of shoulders at the connection between the first apertures and the slit, and a second pair of shoulders at the connection between the second apertures and the slit, the shoulders provided to prevent opening of the slit until an appropriate amount of force is applied to the shoulder by one of the edges of the ring connector.

3. The adjustable page of claim 1, wherein the apertures have a diameter corresponding in size to the length of the major axis of the cross-section of the ring connectors.

4. The adjustable page of claim 1, wherein the substrates have a first, a second, and a third series of first and second apertures.

5. The adjustable page of claim 4, wherein a first, second, and third ring connector pass through the first, second, and third series of apertures, respectively.

6. The adjustable page of claim 5, wherein initially, the first, second, and third ring connectors are all aligned with the first aperture of the first, second, and third series of apertures, respectively.

7. The adjustable page of claim 6, wherein once a certain amount of force is applied, the substrate will transition such that the first, second, and third ring connectors will all be aligned with the second aperture of the first, second, and third series of apertures.

8. The adjustable page of claim 1, wherein the slit comprises an arc-shaped portion; wherein the slit connects to each aperture at a point along the centerline.

9. The adjustable page of claim 1, wherein the slit comprises a sloped center portion between two terminal portions each connected to one of the pair of apertures, wherein the sloped center portion is not perpendicular to the centerline, and wherein at least one of the terminal portions enters its associated aperture along a path tangent to the periphery of the aperture.

10. The adjustable page of claim 1, wherein the slit comprises a center portion between two terminal portions each connected to one of the pair of apertures, wherein the center portion is perpendicular to the centerline, and wherein at least one of the terminal portions enters its associated aperture along a path tangent to the periphery of the aperture.

11. The adjustable page of claim 1, wherein the slit comprises a sloped portion between two terminal portions each connected to one of the pair of apertures, the sloped portion having two ends, wherein at least one of the two ends enters its associated aperture along a path tangent to the periphery of the aperture.

12. The adjustable page of claim 1, wherein the slit comprises a sloped portion between two terminal portions each connected to one of the pair of apertures, the sloped portion having two ends, wherein each the two ends enters its associated aperture along a path tangent to the periphery of the aperture and on opposite sides of the centerline.

13. The adjustable page of claim 1, wherein the slit comprises a sloped portion between two terminal portions each connected to one of the pair of apertures, the sloped portion having two ends, wherein each the two ends enters its associated aperture along a path tangent to the periphery of the aperture and on the same side of the centerline.

14. An adjustable page to be received into a plurality of ring connectors each having a leading edge and a trailing edge, the adjustable page comprising:
a flexible substrate having a first surface and a second surface, the substrate having plurality of pairs of apertures, each pair of apertures having a first aperture and a second aperture extending through the substrate from the first surface to the second surface thereof, and each pair of apertures having an openable and reclosable slit of narrow width joining the first and second apertures; and,
a first pair of shoulders at the connection between the first apertures and the slit, and a second pair of shoulders at the connection between the second apertures and the slit, the shoulders provided to prevent opening of the slit until an appropriate amount of force is applied to the shoulder by one of the edges of the ring connector
wherein a centerline is defined between the centers of the first and second apertures, and
wherein the slit comprises at least one portion that is non-linear or is located along a path apart from said centerline.

15. The adjustable page of claim 14, wherein when an appropriate amount of force is applied, the leading edge of the ring connector will displace the shoulder and transition the slit from a normally closed state to an open state, and wherein the slit returns to the normally closed state after the ring connectors are positioned in the aperture.

16. The adjustable page of claim 14, wherein the ring connectors have a generally circumferential perimeter.

17. The adjustable page of claim 16, wherein the cross-sectional geometry of the ring connectors is consistent about the perimeter.

18. The adjustable page of claim 14, wherein the apertures have a diameter corresponding in size to the length of the major axis of the cross-section of the ring connectors.

19. The adjustable page of claim 14, wherein the substrates have a first, second, and third series of first and second apertures.

20. The adjustable page of claim 19, wherein initially, a first, second, and third ring connector pass through the first aperture of the first, second, and third series of apertures, respectively.

21. The adjustable page of claim 20, wherein once a certain amount of force is applied, the substrate will transition such that the first, second, and third ring connectors will all be aligned with the second aperture of the first, second, and third series of apertures.

22. An adjustable page to be received into a plurality of ring connectors each having a leading edge and a trailing edge, the adjustable page comprising:
a flexible substrate having a first surface, a second surface and an edge, the substrate having plurality of pairs of apertures, each pair of apertures having a first aperture and a second aperture extending through the substrate from the first surface to the second surface thereof, and each pair of apertures having an openable and reclosable slit of substantially zero width joining the first and second apertures, the slit adapted to transition from a normally closed state to an open state, and back to the normally closed state; and,
a first pair of shoulders at the connection between the first apertures and the slit, and a second pair of shoulders at the connection between the second apertures and the slit, the shoulders provided to prevent opening of the slit until an appropriate amount of force is applied to the shoulder by one of the edges of the ring connector
wherein a centerline is defined between the centers of the first and second apertures, and wherein the slit comprises at least one portion that is non-linear or is located along a path apart from said centerline.

23. The adjustable page of claim 22, wherein the cross-section of the ring connectors is consistent about the perimeter.
